(19) United States
(12) Patent Application Publication
(10) Pub. No.: US 2025/0292579 A1
(43) Pub. Date: Sep. 18, 2025

(54) METHOD AND SYSTEM FOR EMPTY SLOT DETECTION AND IDENTIFICATION

(71) Applicant: DoorDash, Inc., San Francisco, CA (US)

(72) Inventors: Weiyu Zhou, Bellevue, WA (US); Sarah Olsen, Brooklyn, NY (US); Chuqi Wang, Mountain View, CA (US)

(21) Appl. No.: 19/082,639

(22) Filed: Mar. 18, 2025

Related U.S. Application Data
(60) Provisional application No. 63/566,558, filed on Mar. 18, 2024.

(51) Int. Cl. G06V 20/50; G06Q 10/087; G06V 10/70

(52) U.S. Cl. CPC G06V 20/50; G06Q 10/087; G06V 10/70

(57) ABSTRACT

A method includes a computer receiving image data of an image of a shelf unit with specific items and item tags adjacent to the specific items. The item tags can comprise machine readable codes. The computer can evaluate the image data to detect one or more empty slots on one or more shelves of the shelf unit. The computer can perform additional processing with respect to the one or more empty slots.

### CROSS-REFERENCES TO RELATED APPLICATIONS

This application claims the benefit of U.S. Provisional Application No. 63/566,558, filed Mar. 18, 2024, which is herein incorporated by reference in its entirety for all purposes.

### SUMMARY

One embodiment is related to a method comprising: receiving, by a computer, image data of an image of a shelf unit with specific items and item tags adjacent to the specific items, wherein the item tags comprise machine readable codes; evaluating, by the computer, the image data to detect one or more empty slots on one or more shelves of the shelf unit; and performing, by the computer, additional processing with respect to the one or more empty slots.

Another embodiment is related to a computer comprising: a processor; and a computer-readable medium coupled to the processor, the computer-readable medium comprising code executable by the processor for implementing a method comprising: receiving image data of an image of a shelf unit with specific items and item tags adjacent to the specific items, wherein the item tags comprise machine readable codes; evaluating the image data to detect one or more empty slots on one or more shelves of the shelf unit; and performing additional processing with respect to the one or more empty slots.

Another embodiment is related to a system comprising: a central server computer; an image database in communication with the central server computer; and an image analysis computer in communication with the image database, the image analysis comprising: a processor; and a computer-readable medium coupled to the processor, the computer-readable medium comprising code executable by the processor for implementing a method comprising: receiving, from the image database, image data of an image of a shelf unit with specific items and item tags adjacent to the specific items, wherein the item tags comprise machine readable codes, wherein the image data is stored in the image database by the central server computer; evaluating the image data to detect one or more empty slots on one or more shelves of the shelf unit; and performing additional processing with respect to the one or more empty slots.

Further details regarding embodiments of the disclosure can be found in the Detailed Description and the Figures.

### BRIEF DESCRIPTION OF THE DRAWINGS

FIG. 1 shows a block diagram illustrating a fulfilment system according to embodiments of the disclosure.

FIG. 2 shows a block diagram of a system according to embodiments.

FIG. 3 shows a block diagram of components of an image analysis computer according to embodiments.

FIG. 4 shows a flowchart illustrating a slot identification method according to embodiments.

FIG. 5 shows an image of item tags on a shelf unit according to embodiments.

FIG. 6 shows images illustrating empty slot detection according to embodiments.

FIG. 7 shows images illustrating image segmentation according to embodiments.

FIG. 8 shows images illustrating a depth map according to embodiments.

FIG. 9 shows an image illustrating item identification according to embodiments.

### DETAILED DESCRIPTION

Prior to discussing embodiments of the disclosure, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor and a computer-readable medium coupled to the processor, the computer-readable medium comprising code, executable by the processor. The user device may also each include an external communication interface for communicating with each other and other entities. Examples of user devices may include a mobile device (e.g., a mobile phone), a laptop or desktop computer, a wearable device (e.g., smartwatch), etc.

“Image data” can include information related to a visible impression obtained by a camera, telescope, microscope, or other device, or displayed on a computer or video screen. Image data can include a plurality of pixels, where each pixel can include data that indicates how that pixel is displayed (e.g., a color value, etc.).

A “shelf unit” can include a surfaces upon which items can be displayed. A shelf unit can include horizontal shelves, gondola shelfs, wire rack shelfs, etc. A shelf unit can display a plurality of items and item tags that relate to the items. A shelf unit can be a portion of a shelf or an entire shelf.

An “item tag” can include a label that includes information about an item. An item tag can include a machine readable code (e.g., a barcode, a QR code, etc.), a price, SKU codes, and/or other information that describes the related item.

A “barcode” can include a machine-readable code that includes a plurality of bars. A barcode can be in the form of numbers and a pattern of parallel lines of varying widths (e.g., bars). A barcode can correspond to and identify a specific item.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory (LSTM)), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “language model” can include a probabilistic model relating to evaluating natural language. A language model can include a large language model (LLM). A large language model can include a transformer and can be utilized to evaluate data other than natural language.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Managing inventory is a time-consuming and challenging process for service providers. Most service providers (e.g., retail merchants such as grocery stores) are only able to count their inventory between once per week and once per month. The difficulties compound when the service provider shares information regarding what items are actually available at the service provider location.

In some cases, transporters can obtain items at service provider locations based on orders provided by end users. The transporters can deliver the items to the end users. However, the end users can select to receive items in a delivery application that are actually not available at the service providers (e.g., the items may be out of stock). If this occurs, it can be difficult and time consuming for the transporter to locate the item or search for a similar item at the service provider or another service provider.

Currently, service providers can use handheld barcode scanners to scan individual item tags on shelves. The service providers can place the handheld barcode scanner close (e.g., a few inches) to the item tag to scan the single item tag. Scanning the item tag can allow the handheld barcode scanner to identify the one item associated with the one scanned item tag. Scanning can be slow since employees in a store need to scan the items one by one in the store.

It takes a long time for a service provider to update their inventory system to represent the items on the shelves at the service provider. The updates to an organization that manages a delivery application would also be delayed.

Further, it may not even be possible to obtain current inventories of items for retailers at any given moment. For example, if a shelf has ten bottles of a particular brand of ice tea at 9 am in the morning, it is possible that all ten bottles may be sold by noon. A consumer or transporter seeking to obtain a bottle of the ice tea at 1 pm would be unaware that the ice tea is out of stock in the short term. Since the retailer does not scan or check the inventory of their items on an hourly basis, they would not know that the ice tea is out of stock.

Embodiments of the disclosure address this problem and other problems individually and collectively.

In embodiments of the invention, computer vision techniques can be used to scan the items on shelves at service providers. An image detection model can be trained on a data set to identify stock keeping units (SKUs) from images of store shelf units.

Embodiments solve the technical problem of how to rapidly update an inventory system regarding the current availability of items. Because the availability of items is current, end users are not presented with and allowed to select out of stock or otherwise missing items in a delivery application. Embodiments also solve the technical problem of handheld barcode scanners being time consuming to utilize across all items at a location. Embodiments provide for the technical solution of processing a plurality of images of shelf units in bulk rather than by individual item (e.g., as was done with barcode scanners), which are captured by a plurality of transporter user devices over time, to determine items that are out of stock or otherwise missing.

User devices can capture images of shelf unit(s) and can product image data from the captured images. The image data can be analyzed to determine missing items from the shelf unit(s). Large scale item tag scanning using images rather than individual barcode scanners can provide access to a broad range of raw in-store information (e.g., shelf photos, scanned item tag barcodes, item names, prices, promotions, etc.). Embodiments provide technical solutions to extract inventory information from these raw image signals.

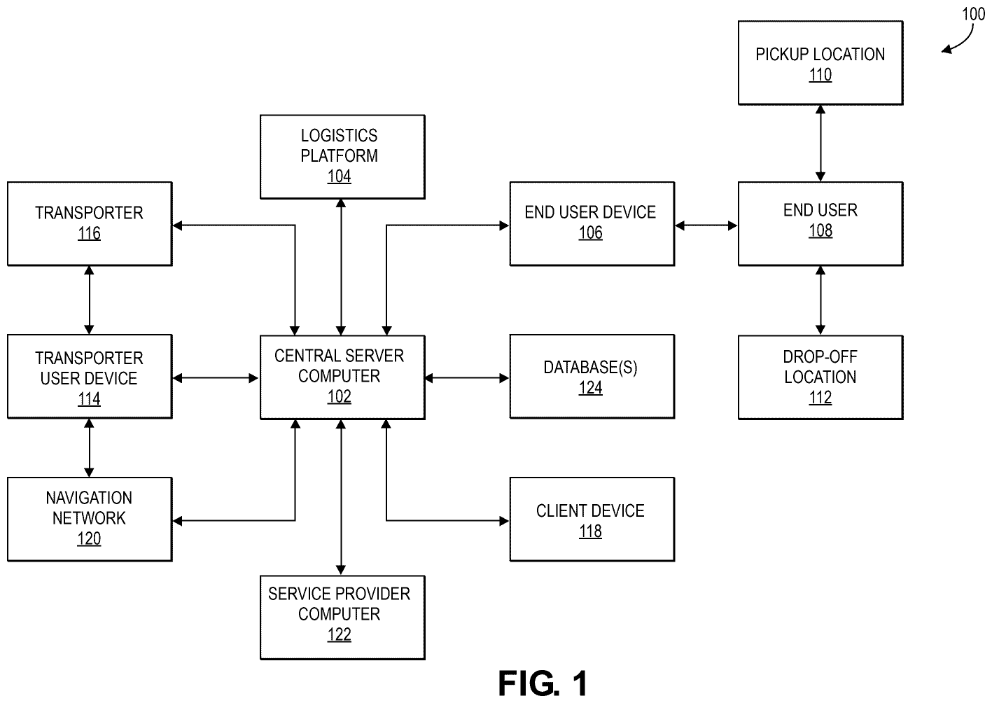

FIG. 1 shows a block diagram illustrating a fulfilment system according to embodiments of the disclosure. The system of FIG. 1 includes a central server computer 102, a logistics platform 104, an end user device 106, an end user 108, a pickup location 110, a drop-off location 112, a transporter user device 114, a transporter 116, a client device 118, a navigation network 120, a service provider computer 122, and database(s) 124.

The central server computer 102 can be in operative communication with the logistics platform 104, the end user device 106, the transporter user device 114, the client device 118, the navigation network 120, the service provider computer 122, and the database(s) 124. The transporter user device 114 can be in operative communication with the navigation network 120.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. For example, although FIG. 1 shows one transporter 116, there can be two, three, or more transporters, transporter user devices, etc.

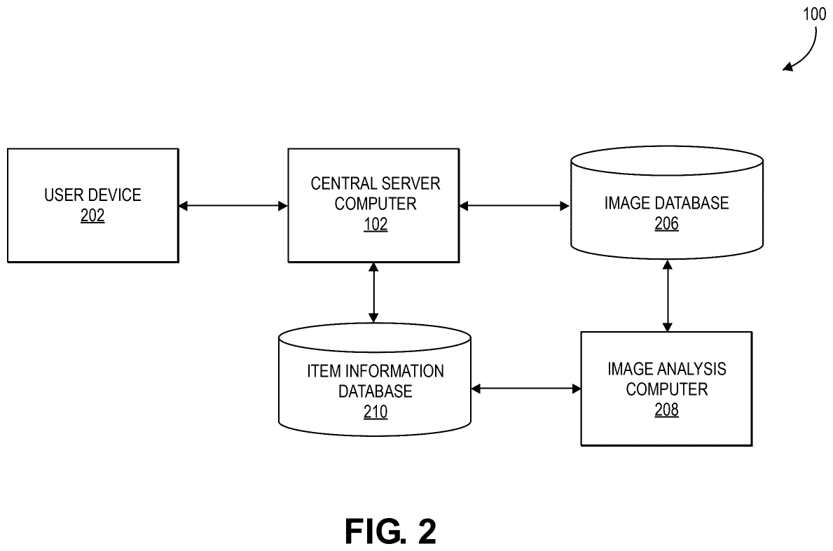

Messages between the devices and the computers in the system 100 in FIG. 1 (as well as FIG. 2) can be transmitted using a secure communications protocols such as, but not limited to, File Transfer Protocol (FTP); HyperText Transfer Protocol (HTTP); Secure Hypertext Transfer Protocol (HTTPS), SSL, and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 102 can include a server computer that can facilitate in the fulfillment of fulfillment requests received from the end user device 106. For example, the central server computer 102 can identify the transporter 116 (from among many candidate transporters) operating the transporter user device 114 as being suitable for satisfying the fulfillment request. The central server computer 102 can identify the transporter user device 114 that can satisfy the fulfillment request based on any suitable criteria (e.g., transporter location, service provider location, end user destination, end user location, transporter mode of transportation, etc.).

The central server computer 102 can receive data relating to a delivery order of items from the service provider computer 122 to the end user 108 at the drop-off location 112. The central server computer 102 can determine a route for delivery of the delivery order. The central server computer 102 can present the routes to a plurality of transporter user devices and/or transporters. The central server computer 102 can receive acceptances from the transporter 116 that will deliver the items from the pickup location 110 to the drop-off location 112.

The central server computer 102 can receive images from user devices that include the end user device 106 and the transporter user device 114. The central server computer 102 can store the images into an image database.

The logistics platform 104 can include a location determination system, which can determine the locations of various user devices such as transporter user devices (e.g., the transporter user device 114) and end user devices (e.g., the end user device 106). The logistics platform 104 can also include routing logic to efficiently route transporters using the transport user devices to various pickup locations and drop-off locations. Efficient routes can be determined based on the locations of the transporters, the locations of the pickup locations, the locations of the drop-off locations, as well as external data such as traffic patterns, the weather, etc. The logistics platform 104 can be part of the central server computer 102 or can be a system that is separate from the central server computer 102.

The end user device 106 can include a device operated by the end user 108. The end user devices 106 can generate and provide fulfillment request messages to the central server computer 102. The fulfillment request message can indicate that the request (e.g., a request for a service) can be fulfilled by the service provider computer 122. For example, the fulfillment request message can be generated based on a cart selected at checkout during a transaction using a central server computer application installed on the end user device 106. The fulfillment request message can include one or more items from the selected cart.

The end user device 106 can provide a fulfillment request message to the central server computer 102 that indicates that the end user device 106 is requesting that the transporter 116 pickup an item from the pickup location 110 (e.g., end user's 108 location) and deliver the item to the drop-off location 112 (e.g., the service provider computer's 122 location).

The pickup location 110 can be a location in which items are stored. In the context of an outbound delivery from an end user at an end user location, examples of the pickup location 110 may be a house or an apartment, a mailbox, a service provider location (e.g., a retail store, a grocery store, a dry cleaning store), a pickup hub, etc. Items can first be obtained from a pickup location 110 and then be transported to the drop-off location 112. Examples of the drop-off location 112 can be similar to the pickup location 110, such as a house or apartment, a mailbox, a retail store, a grocery store, a dry cleaning store, a pickup hub, etc. In one example, the pickup location 110 can be a pizza parlor from which the end user 108 orders a pizza. The drop-off location 112 can be an apartment in which the end user 108 resides.

The transporter user device 114 can include a device operated by the transporter 116. The transporter user device 114 can include a smartphone, a wearable device, a personal assistant device, etc. The transporter 116 can accept an end user's fulfillment request via an acceptance message. For example, the transporter user device 114 can generate and transmit a request to fulfil a particular end user's fulfillment request to the central server computer 102. The central server computer 102 can notify the transporter user device 114 of the fulfillment request. The transporter user device 114 can respond to the central server computer 102 with a request to perform the delivery to the end user as indicated by the fulfillment request.

In some embodiments, the transporter 116 can be an operator of a vehicle. In other embodiments, the transporter 116 can be a vehicle that can be operated by an operator or can be autonomous. The vehicle can include a car, a truck, a van, a motorcycle, a bicycle, a drone, or other vehicle.

The client device 118 can request information from the central server computer 102. The client device 118 can be operated by a user that requests information from the central server computer 102 related to a delivery. In some embodiments, the client device 118 can be the transporter user device 114. In other embodiments, the client device 118 can be the end user device 106.

The navigation network 120 can provide navigational directions to the transporter user device 114. For example, the transporter user device 114 can obtain a location from the central server computer 102. The location can be a service provider parking location, a service provider location, an end user parking location, an end user location, etc. The navigation network 120 can provide navigational data to the location. For example, the navigation network 120 can be a global positioning system that provides location data to the transporter user device 114.

The service provider computer 122 include computers operated by a service provider. For example, the service provider computer 122 can be a food provider computer that is operated by a food provider. The service provider computer 122 can offer to provide services to the end user 108 of the end user device 106. In embodiments of the invention, the service provider computer 122 can receive requests to prepare one or more items for delivery from the central server computer 102. The service provider computer 122 can initiate the preparation of the one or more items that are to be delivered to the end user 108 of the end user device 106 by the transporter 116 of the transporter user device 114.

The database(s) 124 can include any suitable database. The database may be a conventional, fault tolerant, relational, scalable, secure database such as those commercially available from Oracle™ or Sybase™. The database(s) 124 can store fulfilment data, resource data, image data, etc.

FIG. 2 shows a system 200 according to embodiments of the disclosure. The system 200 comprises a user device 202, a central server computer 102, an image database 206, an image analysis computer 208, and an item information database 210.

The user device 202 can be in operative communication with the central server computer 102. The central server computer 102 can be in operative communication with the image database 206 and the item information database 210. The image analysis computer 208 can be in operative communication with the image database 206 and the item information database 210.

For simplicity of illustration, a certain number of components are shown in FIG. 2. It is understood, however, that embodiments of the invention may include more than one of each component. In addition, some embodiments of the invention may include fewer than or greater than all of the components shown in FIG. 2.

The user device 202 can include an end user device or a transporter user device operated by a user. The user device 202 can include a device such as a smartphone, a wearable device, a laptop computer, etc. The user device 202 can include a camera that can capture image data of an image. The user device 202 can provide image data for one or more images to the central server computer 102.

The user device 202 can be operated by a transporter during a fulfilment request (e.g., a delivery) of an item from the service provider location to an end user. The transporter can be prompted by the user device 202 to capture image data using the user device 202 of a shelf unit at the service provider location. The user device 202 can include a camera capable of capturing image data. After obtaining the image data, the user device 202 can provide the image data to the central server computer 102. The user device 202 can also provide additional data related to the image data to the central server computer 102. For example, the user device 202 can provide a service provider location, a service provider identifier, a service provider location identifier, an aisle number, user device orientation data, image metadata, and/or other data related to the service provider location, shelf unit(s), and/or user device 202.

In some embodiments, the system 200 can include a plurality of user devices that are in communication with the central server computer 102. Each user device of the plurality of user devices can provide additional image data to the central server computer 102.

The central server computer 102 can include a server computer that can communicate with a plurality of user devices to obtain image data and aid in processing fulfillment requests to provide resources from service providers to end users via transporters. The central server computer 102 can store received image data into the image database 206.

The central server computer 102 can maintain and update item listings that can be accessible a delivery application managed by the central server computer 102. The delivery application can be installed on end user devices and can allow end users to select items from the item listings to have delivered to the end user from a service provider location by a transporter. The central server computer 102 can update item listings based on item information data entries in the item information database 210.

In some embodiments, the central server computer 102 can maintain and update item listings on the delivery application using out of stock data from the item information database 210 as well as inventory information provided from the service provider computer 122. For example, the item information database 210 can indicate that a particular item is in stock at the service provider location. The service provider computer 122 can provide inventory information that indicates that there are fifty-five instances of the particular item at the service provider location. The central server computer 102 can update the item listing for the particular item based on the information from the item information database 210 and the information from the service provider computer 122.

The image database 206 can store image data. The image database 206 can store information that relates the image data other data. For example, the image database 206 can store the image data in association with the service provider location, the service provider identifier, the service provider location identifier, the aisle number, user device orientation data, the image metadata, and/or other data.

The image analysis computer 208 can include computer that is configured to process image data. The image analysis computer 208 can be an image processing computer. The image analysis computer 208 can be a laptop computer, a desktop computer, a server computer, etc. The image analysis computer 208 can obtain image data from the image database 206. The image analysis computer 208 can receive image data of an image of a shelf unit with specific items and item tags comprising barcodes adjacent to the specific items. The image analysis computer 208 can analyze the image data.

The image analysis computer 208 can detect one or more empty slots on one or more shelves of the shelf unit after analyzing the image data. The computer can perform additional processing with respect to the one or more empty slots.

In some embodiments, after processing the image data, the image analysis computer 208 can generate an item information data entry that indicates that the item is associated with an empty slot. The image analysis computer 208 can store the item information data entry into the item information database 210.

The item information database 210 can store item information data entries for items that are provided by service providers to end users via transporters. The item information database 210 can store information that can indicate that a particular item is out of stock. The item information database 210 can store item identifiers (e.g., item name, item number, etc.) along with an indication of whether or not an item is out of stock of otherwise missing from the shelf units at a service provider location.

The image database 206 and the item information database 210 can include any suitable databases. The databases may be a conventional, fault tolerant, relational, scalable, secure database such as those commercially available from Oracle™ or Sybase™.

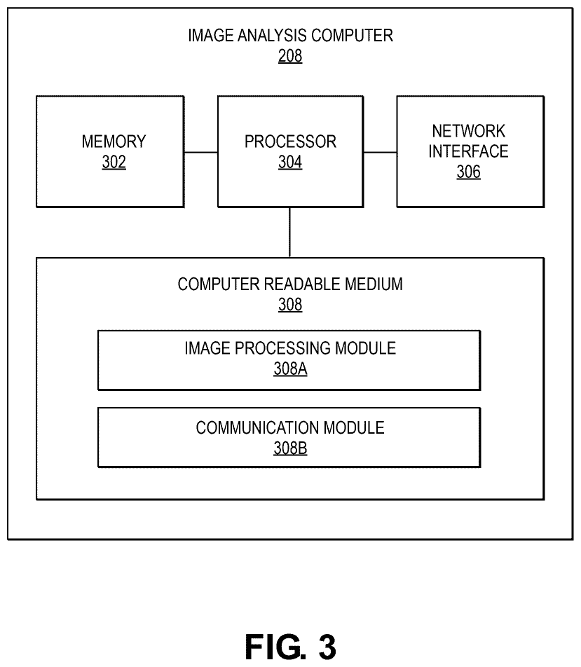

FIG. 3 shows a block diagram of an image analysis computer 208 according to embodiments. The exemplary image analysis computer 208 may comprise a processor 304. The processor 304 may be coupled to a memory 302, a network interface 306, and a computer readable medium 308. The computer readable medium 308 can comprise modules. The computer readable medium 308 can include an image processing module 308A and a communication module 308B.

The memory 302 can be used to store data and code. For example, the memory 302 can store machine learning model training data, machine learning model weights, image data, machine readable code data, item data, etc. The memory 302 may be coupled to the processor 304 internally or externally (e.g., cloud based data storage), and may comprise any combination of volatile and/or non-volatile memory, such as RAM, DRAM, ROM, flash, or any other suitable memory device.

The computer readable medium 308 may comprise code, executable by the processor 304, for performing a method comprising: receiving, by a computer, image data of an image of a shelf unit with specific items and item tags adjacent to the specific items, wherein the item tags comprise machine readable codes; evaluating, by the computer, the image data to detect one or more empty slots on one or more shelves of the shelf unit; and performing, by the computer, additional processing with respect to the one or more empty slots.

The image processing module 308A may comprise code or software, executable by the processor 304, for processing images. The image processing module 308A, in conjunction with the processor 304, can process image data to extract information from the image data. For example, the image processing module 308A, in conjunction with the processor 304, can determine items, item tags, and/or segments in the image data. The image processing module 308A, in conjunction with the processor 304, can determine one or more empty slots in the image data that indicate that an item is missing at a particular location on a shelf unit.

The communication module 308B can include may comprise code or software, executable by the processor 304, for communicating with other devices. The communication module 308B, in conjunction with the processor 304, can generate messages, receive messages, and parse messages. The communication module 308B, in conjunction with the processor 304, can receive image data. The communication module 308B, in conjunction with the processor 304, can generate and transmit item information data entries.

The network interface 306 may include an interface that can allow the image analysis computer 208 to communicate with external computers. The network interface 306 may enable the image analysis computer 208 to communicate data to and from another device (e.g., the image database 206, etc.). Some examples of the network interface 306 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 306 may include Wi-Fi™. Data transferred via the network interface 306 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 306 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

Embodiments can utilize an image tag evaluation model to evaluate item tags in an image. The image tag evaluation model can utilize computer vision to extract image features and can utilize optical character recognition (OCR) to obtain text information from the images of the item tags. A technical advantage of such a method over using barcode scanners is that contextual information (e.g., the relationship between items and item tags on the shelf unit) can be extracted from the images. During image processing, the image analysis computer 208 can learn item identifiers, item names, and item prices for items that appear in the image as well as determine empty slots that correspond to item tags with no items.

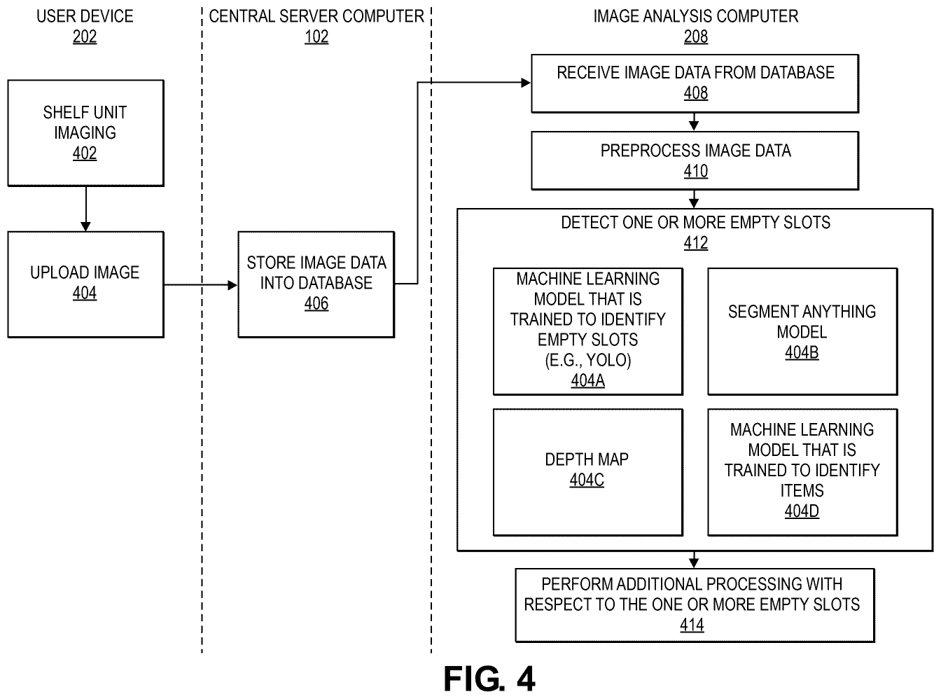

FIG. 4 shows a flowchart illustrating a slot identification method according to embodiments. The method illustrated in reference to FIG. 4 will be described in the context of a transporter operating the user device 202 to obtain images of shelf units at a service provider location. The user device 202 can provide the image data to the central server computer 102. The central server computer 102 can store the image data into the image database 206.

At step 402, the user device 202 can perform shelf unit imaging. The user device 202 can obtain images of shelf units that include items and item tags. The user device 202 can capture the images of the shelf units using a camera integrated into the user device 202. The user device 202 can be a transporter user device that is operated by a transporter or can be an end user device that is operated by an end user.

For example, the user device 202 can be operated by a transporter that has arrived at the service provider location. The user device 202 can detect that it has entered the service provider location using a global positioning system (GPS) or other location identification system. The user device 202 can display a scan shelf unit message on the display of the user device 202 to the transporter. The scan shelf unit message can indicate a particular shelf unit to scan. A shelf unit can include an entire shelf that holds items, or a portion of a shelf with items. The transporter can utilize the user device 202 to capture an image of the indicated shelf unit.

In some embodiments, the user device 202 can include a delivery application that can allow end users to select items for delivery from a service provider location to an end user location via a transporter. The delivery application can notify, via user devices, transporters to capture images.

At step 404, after capturing image data of an image of the shelf unit, the user device 202 can upload the image data to the central server computer 102. The user device 202 can transmit the image data to the central server computer 102 using the delivery application installed on the user device 202.

At step 406, after receiving the image data, the central server computer 102 can store the image data in the image database 206 (not shown in FIG. 4). The image analysis computer 208 can access the image data in the image database 206.

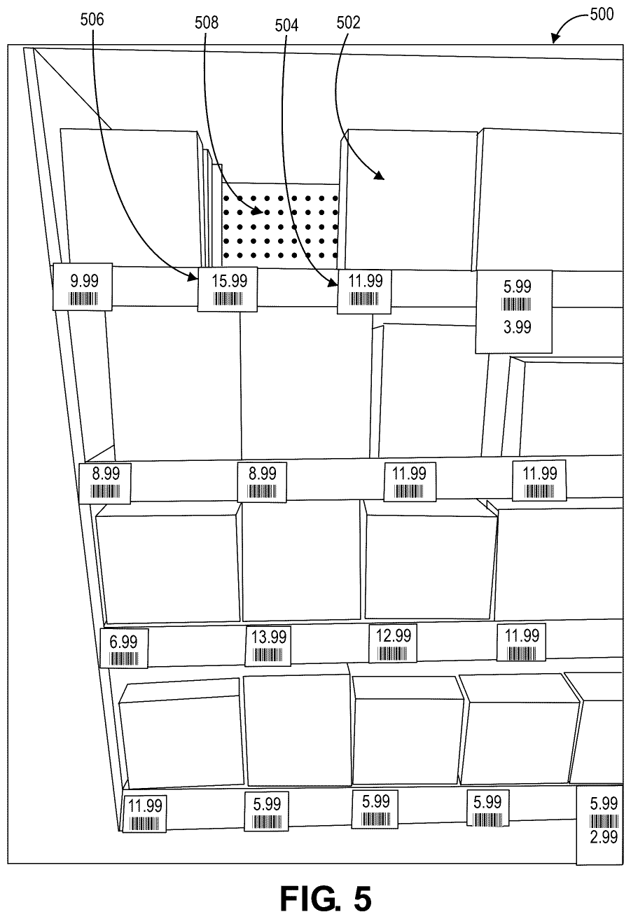

At step 408, the image analysis computer 208 can receive image data. The image analysis computer 208 can obtain the image data from the image database 206. The image analysis computer 208 can receive image data of an image of a shelf unit with specific items and item tags comprising machine readable codes adjacent to the specific items. For example, the image analysis computer 208 can receive image data of an image illustrated in FIG. 5.

At step 410, after obtaining the image data, the image analysis computer 208 can preprocess the image data. The image analysis computer 208 can modify the image data such that the image data can later be more effectively processed. The image analysis computer 208 can perform any type of image preprocessing on the image data. For example, the image analysis computer 208 can resize the image data, grayscale the image data, perform noise reduction on the image data, normalize the image data, perform binarization on the image data, enhance the image data's contrast, etc.

The image analysis computer 208 can resize image data to a uniform size such that later processes can utilize a standardized image data input size. In some embodiments, resizing (e.g., scaling) can aid in reducing the number of pixels from an image. Reducing the number of pixels can provide for the advantage of reducing computation time in later processes. Resizing can also aid with zooming in on images.

The image analysis computer 208 can grayscale the image data. Gray scaling can include converting color images to grayscale, which can simplify the image data and reduce computational needs for some algorithms.

The image analysis computer 208 can perform noise reduction on the image data. The image analysis computer 208 can apply smoothing, blurring, and filtering techniques to the image data to remove unwanted noise from images. Example noise reduction techniques can include using a Gaussian blur and a median blur.

The image analysis computer 208 can normalize the image data. During normalization, the image analysis computer 208 can adjusts the intensity values of the pixels in the image data to a desired range (e.g., between 0 and 1).

The image analysis computer 208 can perform binarization on the image data. Binarization can include converting a grayscale image to a black and white by thresholding each pixel to a value of 0 or 1.

The image analysis computer 208 can enhance the image data's contrast by evaluating a histogram of the image data's pixels. The image analysis computer 208 can adjust the contrast of the image data using histogram equalization.

During image data preprocessing, the image analysis computer 208 can obtain the item tag data from the image data. The image analysis computer 208 can identify the item tags in the image data. The image analysis computer 208 can extract information (e.g., item name, machine readable code, price, etc.) from the item tag in the image data. For example, the image analysis computer 208 can identify item tags in the image data using a machine learning model to identify item tags in images or other suitable item tag determination method. The image analysis computer 208 can extract data from the item tags in the image data. For example, the image analysis computer 208 can extract item data such as a name, a price, a promotion, a price per unit, etc. from the item tag. The image analysis computer 208 can also extract a machine readable code from the item tag, where the machine readable code identifies the item and can indicate information about the item. For example, the image analysis computer 208 can determine additional information for each item based on the machine readable codes on the item tags, where the additional information includes an item identifier.

As an illustrative example, the image data can be the image data illustrated in FIG. 5, which also indicates example identified item tags on the shelf unit. FIG. 5 shows an image of item tags on a shelf unit according to embodiments. FIG. 5 illustrates an image that can be utilized in the identification of items that are no longer on the shelf unit.

FIG. 5 includes an image 500 of a shelf unit that includes a plurality of items including the item 502, a plurality of item tags including the first item tag 504 and the second item tag 506, and an empty slot 508. The first item tag 504 can correspond to the item 502. The second item tag 506 can correspond to the empty slot 508.

The image analysis computer 208 can obtain the image 500 from the image database 206. The image analysis computer 208 can preprocess the image data to identify the plurality of item tags in the image 500. For example, the image analysis computer 208 can utilize a machine learning model (such as a convolutional neural network) to identify item tags in the image 500. The image analysis computer 208 can identify the first item tag 504 and the second item tag 506.

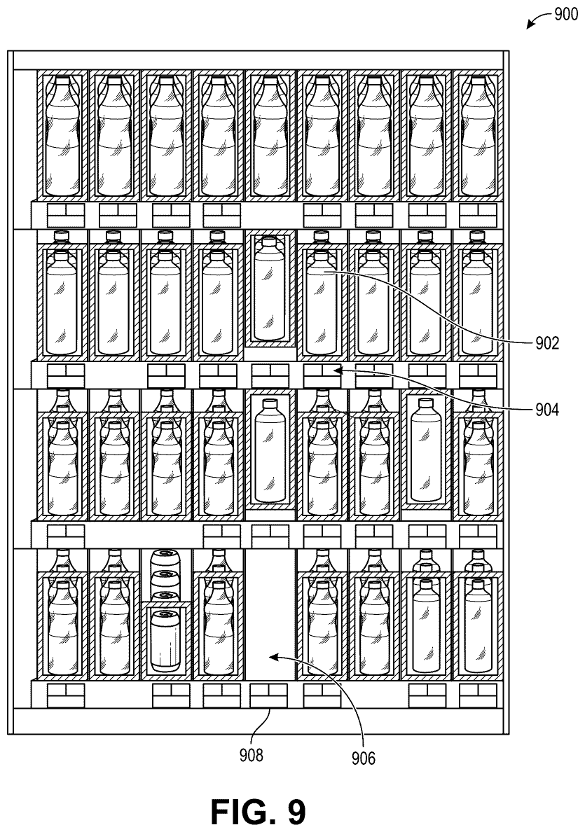

The image analysis computer 208 can also, in some embodiments, identify items in the image 500. For example, the image analysis computer 208 can identify the item 502 in the image. The image analysis computer 208 can identify items on the shelf using an item detection method as described in further detail in reference to FIG. 9.

Referring back to FIG. 4, at step 412, after receiving the image data, the image analysis computer 208 can detect one or more empty slots on one or more shelves of the shelf unit. An empty slot can be a location on the shelf unit that does not have an item. An empty slot may be located in the image proximate to an item tag. For example, an empty slot may occur at the service provider location when an item is out of stock, but the item tag remains on the shelf unit. For example, the image analysis computer 208 can identify the empty slot 508 in FIG. 5.

The image analysis computer 208 can detect the one or more empty slots on one or more shelves of the shelf unit using one or more detection methods.

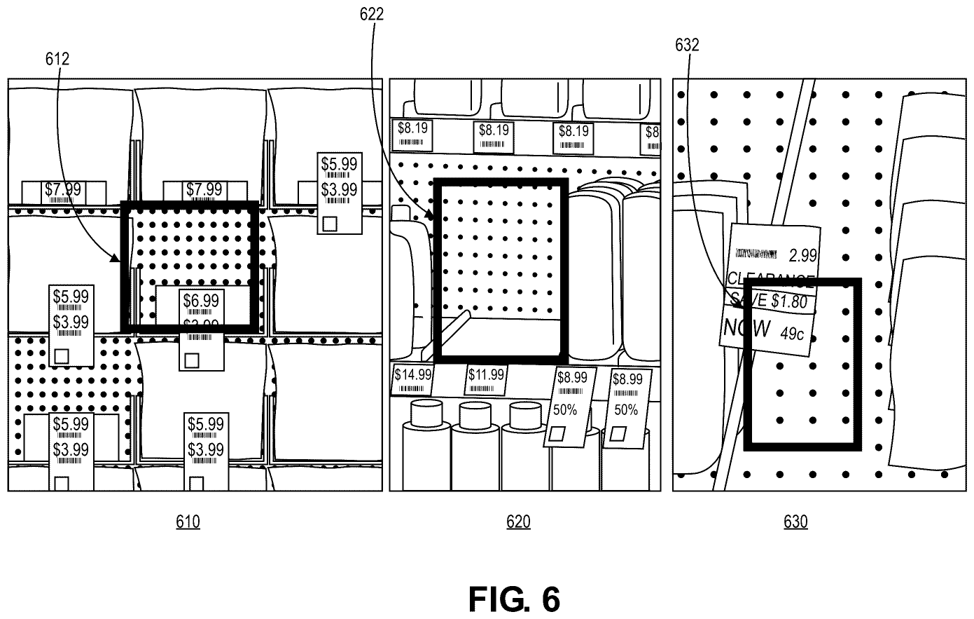

For example, the image analysis computer 208 can detect the one or more empty slots using a machine learning model that is trained to identify empty slots 404A on a shelf unit, as described in further detail in reference to FIG. 6.

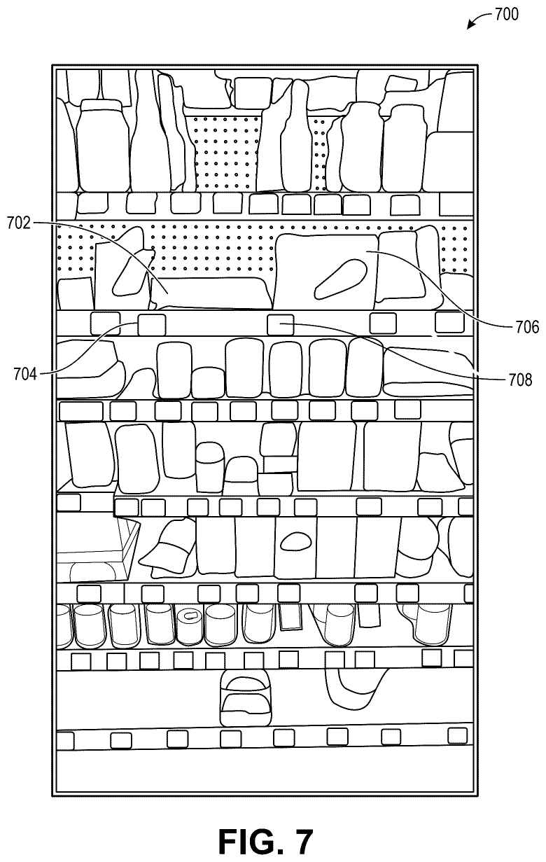

For example, the image analysis computer 208 can detect the one or more empty slots using a segment anything model 404B, as described in further detail in reference to FIG. 7.

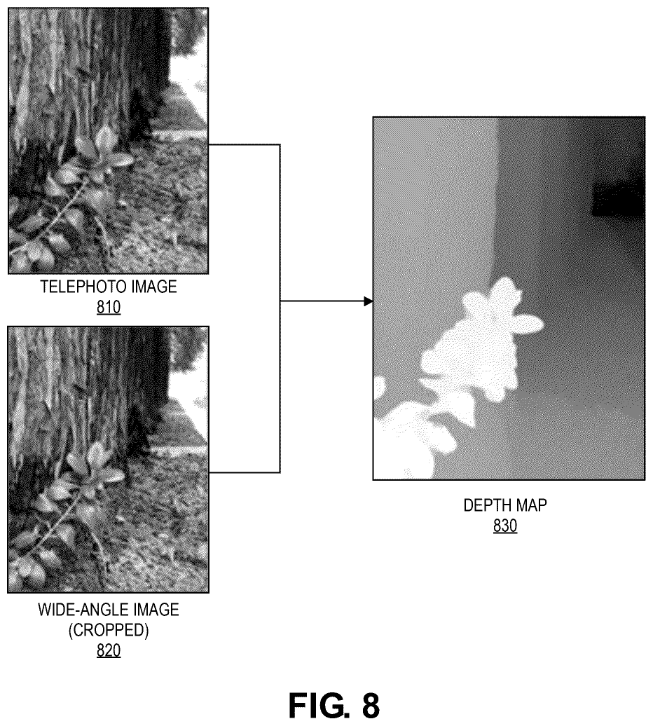

For example, the image analysis computer 208 can detect the one or more empty slots using a depth map 404C, as described in further detail in reference to FIG. 8.

For example, the image analysis computer 208 can detect the one or more empty slots using a machine learning model that is trained to identify items 404D on the shelf unit and identify item tags that do not correspond to identified items, as described in further detail in reference to FIG. 9.

At step 414, after detecting the one or more empty slots, the image analysis computer 208 can perform additional processing with respect to the one or more empty slots.

For example, additional processing can include the image analysis computer 208 identifying item tags associated with the shelf unit. The image analysis computer 208 can then correlate the empty slots with one or more item tags. The image analysis computer 208 can determine items associated with the item tags and the empty slots. As an illustrative example in reference to FIG. 5, the image analysis computer 208 can analyze the image 500 to determine the empty slot 508. The image analysis computer 208 can correlate the empty slot 508 to the second item tag 506 based on proximity and/or other features of the image.

As another example, additional processing can include the image analysis computer 208 determining that an empty slot does not correspond to an item tag. For example, the image analysis computer 208 can identify an empty slot in the image data, but does not identify an item tag that is proximate to the empty slot. The image analysis computer 208 can determine that the empty slot does not correspond to an item with an item tag.

As another example, additional processing can include the image analysis computer 208 generating an item information data entry that indicates that the item is associated with an empty slot. The image analysis computer 208 can store the item information data entry into the item information database 210.

As another example, in some embodiments, additional processing can include the image analysis computer 208 determining information about each item in the image using the item tags and the machine readable codes on the item tags. For example, the machine readable codes can be barcodes or QR (quick response) codes. The machine readable codes can be modified Plessey barcodes, universal product code (UPC) barcode, European article number (EAN) barcode, code 39 barcodes, code 128 barcodes, interleaved 2 of 5 barcodes, code 93 barcodes, codabar barcodes, GS1 barcodes, data matrix codes, PDF417 codes, Aztec codes, etc. The image analysis computer 208 can determine information about the items using the machine readable codes.

FIG. 6 shows images illustrating empty slot detection according to embodiments. The image analysis computer 208 can train, maintain, and utilize a computer vision (CV) machine learning model to identify empty slots in image data of shelf units. FIG. 6 includes a first image 610 with a first identified empty slot 612, a second image 620 with second identified empty slot 622, and a third image 630 with a third identified empty slot 632.

The computer vision machine learning model can be designed to evaluate visual data based on features and contextual information identified during training. This training can allow the computer vision machine learning model to interpret images as well as video (e.g., which can be a sequence of images) and apply those interpretations to predictive or decision making tasks.

The computer vision machine learning model can be a convolutional neural network. Convolutional neural networks can be neural networks with a multi-layered architecture that are used to gradually reduce data and calculations to the most relevant set. This most relevant set is then compared against known data (e.g., such as a label) to identify or classify the data input.

When an image is processed by the computer vision machine learning model, each base color used in the image (e.g. red, green, blue) can represented as a matrix of values. These values are evaluated and condensed into 3D tensors (e.g., in the case of color images), which can be collections of stacks of feature maps tied to a section of the image. These tensors can be created by passing the image through a series of convolutional layers and pooling layers, which are used to extract the most relevant data from an image segment and condense it into a smaller, representative matrix. This process can be repeated numerous times, which can depend on the number of convolutional layers in the architecture. The final features extracted by the convolutional process are sent to a fully connected layer, which can generate predictions.

Computer vision techniques can utilize two different types of object detection: two-step object detection and one-step object detection.

For two-step object detection, the first step can utilize a region proposal network (RPN), which can provide a number of candidate regions that may contain important objects in the image data. The second step can include passing region proposals to a neural classification architecture, commonly a region-based convolutional neural network (RCNN) based hierarchical grouping algorithm, or region of interest (ROI) pooling in a fast RCNN. These approaches are provided for the tradeoff of increased accuracy, but decreased speed.

One-step object detection can be utilized for real-time object detection. One-step object detection architectures can process image data faster than two-step object detection architectures. One-step object detection architectures can include you only look once (YOLO), single shot multibox detector (SSD), and RetinaNet. The one-step object detection architectures combine the detection and classification steps by regressing bounding box predictions. Each determined bounding box can be represented with a few coordinates, making it easier to combine the detection and classification step and speed up processing. The computer vision machine learning model can utilize one-step object detection.

The image analysis computer 208 can train the computer vision machine learning model. The image analysis computer 208 can obtain a set of image data from the image database 206. The image analysis computer 208 can applying one or more preprocessing methods to each image data including mirroring, rotating, smoothing, contrast reduction, noise reduction, scaling, rectifying, etc. to create a preprocessed set of image data.

After preprocessing each image data in the set of image data, the image analysis computer 208 can create a first training set comprising the preprocessed set of image data. The image analysis computer 208 can train the computer vision machine learning model in a first training iteration using the first training set.

The image analysis computer 208 can iteratively train the computer vision machine learning model to identify empty slots in image data. The image analysis computer 208 can create a second training set for a second training iteration. The image analysis computer 208 can obtain a second set of image data from the image database 206. The image analysis computer 208 can preprocess the image data in the second set of image data to form a second preprocessed set of image data. The image analysis computer 208 can create the second training set using the preprocessed second set of image data from the image database 206. The image analysis computer 208 can train the computer vision machine learning model using the second training set.

During each training iteration, the image analysis computer 208 can optimize a loss function based on values determine during training. The image analysis computer 208 can optimize the loss function to update weights in the computer vision machine learning model.

After training the computer vision machine learning model, the image analysis computer 208 can utilize the computer vision machine learning model during an inference phase. During inference, the computer vision machine learning model can detect the first identified empty slot 612 in the first image 610, the second identified empty slot 622 in the second image 620, and the third identified empty slot 632 in the third image 630.

The image analysis computer 208 can also perform an item tag detection process using the image data. The item tag detection process can identify the item tags that are included in the image data. The item tag detection process can include a machine learning model that is trained to identify item tags in image data. During the item tag detection process, the image analysis computer 208 can determine a plurality of item tags that include machine readable codes. The image analysis computer 208 can utilize the machine readable code on each item tag as well as other item information on the item tag (e.g., item name, item price, etc.) to obtain item data for the item tag.

After detecting the empty slots and the item tags in the image data of the shelf unit, the image analysis computer 208 can match the identified empty slots with associated item tags. The image analysis computer 208 can match empty slots with proximate item tags. The image analysis computer 208 can determine an item tag of the item tags in the image data that is most proximate to the empty slot.

For example, the image analysis computer 208 can determine a distance between the empty slot in the image data with each item tag of the item tags in the image data. The image analysis computer 208 can determine the most proximate item tag based on the determined distances.

After matching the empty slot with the relevant item tag, the image analysis computer 208 can generate an item information data entry that indicates that the item identified by the item tag is out of stock or otherwise missing from the shelf unit. The image analysis computer 208 can store the item information data entry into the item information database 210. The item information data entry can include an item identifier obtained from the item tag.

At a later point in time, the central server computer 102 can update an item listing for the item on a delivery application using the item information data entry.

FIG. 7 shows images illustrating image segmentation according to embodiments. FIG. 7 includes an image 700 of a shelf unit. The image analysis computer 208 can detect one or more empty slots in the image 700 using a segment anything model (SAM). The image 700 illustrates segmented images of a shelf unit. The image 700 includes an empty slot segment 702, a first item tag segment 704, an item segment 706, and a second item tag segment 708.

The image analysis computer 208 can generate a plurality of segments for the image 700 using the segment anything model. The segment anything model can be a pretrained model that is trained to identify regions in images. The segment anything model can include encoders, transformers, and/or decoders. For example, the segment anything model can include a ViT-H image encoder that runs once per image and outputs an image embedding, a prompt encoder that embeds input prompts, and a transformer based mask decoder that predicts object masks from the image embedding and the prompt embedding. The segment anything model can be a segment anything model as described in reference to “Segment Anything” by Alexandar Kirillov et al. 2023 (Arxiv reference arXiv: 2304.02643 [cs.CV]), which is herein incorporated by reference.

The image analysis computer 208 can generate the empty slot segment 702, the first item tag segment 704, the item segment 706, and the second item tag segment 708 using the segment anything model.

After segmenting the image 700 into the plurality of segments, the image analysis computer 208 can utilize a classification machine learning model for each segment to identify the contents of the segment. For example, the image analysis computer 208 can classify a segment as an item, an item, tag, a shelf unit, or an empty slot.

The classification machine learning model can be trained to determine a classification of a segment of the image 700. The classification can be item, empty slot, or item tag. In some cases, the classifications can indicate further detail about the segment (e.g., a particular type of item, a particular size of slot, etc.).

As an example, the image analysis computer 208 can input the empty slot segment 702 into the classification machine learning model. The classification machine learning model can determine a classification for the segment. The classification machine learning model can output a classification of “empty slot” for the empty slot segment 702. The image analysis computer 208 can input the first item tag segment 704 into the classification machine learning model. The classification machine learning model can output a classification of “item tag” for the first item tag segment 704. The image analysis computer 208 can input the item segment 706 into the classification machine learning model. The classification machine learning model can output a classification of “item” for the item segment 706. The image analysis computer 208 can input the second item tag segment 708 into the classification machine learning model. The classification machine learning model can output a classification of “item tag” for the second item tag segment 708.

FIG. 8 shows images illustrating a depth map according to embodiments. The image analysis computer 208 can determine one or more empty slots in image data using depth map(s). FIG. 8 includes a telephoto image 810, a wide-angle image (cropped) 820, and a depth map 830. The image analysis computer 208 can determine or otherwise obtain a depth map of the image of the shelf unit. The depth map 830 can be constructed using the telephoto image 810 and the wide-angle image (cropped) 820. The depth map 830 can be constructed by the camera and user device during image capture or can later be created by the image analysis computer 208.

The image analysis computer 208 can identify one or more empty slots in the image of the shelf unit using the depth map of the image of the shelf unit. The depth map can indicate how far a specific portion of the image is from the camera that captured the image. The image analysis computer 208 can identify empty slots in the image of the shelf unit based on the depth of the image at the locations of the empty slots. Portions of the image that have a larger depth, as indicated in the depth map, can correspond to empty slots on the shelf unit.

The image analysis computer 208 can utilize the depth map 830 for an image along with the image data for the image. The image analysis computer 208 can determine items and/or item tags in the image data as described herein. The image analysis computer 208 can then utilize the depth map 830 to identify empty slots on the shelf unit.

The image analysis computer 208 can identify depth locations in the depth map 830 that indicate a depth greater than a threshold depth. For example, the image analysis computer 208 can identify depth locations in the depth map 830 based on a threshold depth of 16 inches (or other distance value) which is indicated in the depth map 830 as a particular shade of gray (e.g., a value of 0.82).

The image analysis computer 208 can compare the identified depth locations in the depth map 830 to locations in the image data. The image analysis computer 208 can identify an empty slot at a location in the image data if no item is identified at the location in the image data and an identified depth location is at the same location.

FIG. 9 shows an image illustrating item identification according to embodiments. The image analysis computer 208 can determine one or more items and one or more item tags in the image data using a computer vision machine learning model. The image analysis computer 208 can determine one or more empty slots in the image data based on item tags that do not correspond to items. FIG. 9 includes an image 900 with an identified item 902, a first identified item tag 904, an empty slot 906, and a second identified item tag 908.

The image analysis computer 208 can train a computer vision machine learning model to identify items on shelf units. The computer vision machine learning model can also identify item tags on the shelf units. The computer vision machine learning model can include a you only look once (YOLO) machine learning model to identify the items and/or the item tags. A you only look once model can be a single-shot detector that uses a fully convolutional neural network (CNN) to process image data. Further details regarding you only look once models can be found in “You Only Look Once: Unified, Real-Time Object Detection” by J Redmon et al. 2015 (Arxiv reference arXiv: 1506.02640 [cs.CV]), which is herein incorporated by reference.

In some embodiments, the computer vision machine learning model can determine information about the items that are identified in the image data. For example, the computer vision machine learning model can identify that an item on the shelf unit in the image is a bottle of soda of a particular brand. The computer vision machine learning model can determine that the item is a particular category of item (e.g., bottle of soda, bottle of water, snack, box of pasta, etc.) that is provided by a particular brand.

Once the items and item tags have been identified in the image 900, the image analysis computer 208 can determine item and item tag pairs that indicate which items correspond to which item tags. The image analysis computer 208 can determine item and item tag pairs based on item and item tag proximity in the image 900. For example, the image analysis computer 208 can associate an item tag located in a region below an item with the item.

As an illustrative example, for each identified item in the image 900, the image analysis computer 208 can attempt to determine an associated item tag. The image analysis computer 208 can iterate through each identified item. The image analysis computer 208 can determine a most proximate (e.g., closest in distance) item tag to the item in the image 900 based on a distance between the item and the item tag.

In some embodiments, the image analysis computer 208 can determine a distance between each item and item tag. The image analysis computer 208 can apply a weighting to the determined distances based on a directionality of the item and item tag vector that points from the item to the item tag. For example, the image analysis computer 208 can give preference to item tags that are below the item by weighting the distance between the item and item tag based on directionality. For example, a typical shelf unit may have item tags under the items. Whereas, for some shelf units, the item tags may be located above an item. In which case, the image analysis computer 208 can apply a weighting that gives preference to item tags that are above the item. Based on the distance calculations and potential weightings, the image analysis computer 208 can determine a weighted most proximate item tag for each item to form an item and item tag pair.

As an illustrative example, the image analysis computer 208 can identify the identified item 902 and the first identified item tag 904. The image analysis computer 208 can evaluate the distance from the identified item 902 to all of the item tags (or a subset of all of the item tags). The image analysis computer 208 can determine that the first identified item tag 904 is the most proximate item tag to the identified item 902 and is below the identified item 902. The image analysis computer 208 can generate an item and item tag pair that includes the identified item 902 and the first identified item tag 904. As such, the image analysis computer 208 can correlate the identified item 902 with the first identified item tag 904.

After determining item and item tag pairs, the image analysis computer 208 can perform a reverse search to determine locations of item tags that lack corresponding identified items. For example, the image analysis computer 208 can determine items tags that don't have associated items.

For example, the second identified item tag 908 does not have an item above the second identified item tag 908 on the shelf unit. The image analysis computer 208 can determine that the second identified item tag 908 is not associated with an item. The image analysis computer 208 can identify the area above the second identified item tag 908 as not including an item. The image analysis computer 208 can identify the area above the second identified item tag 908 as the empty slot 906.

In some embodiments, the image analysis computer 208 can obtain a better understanding of both items on the shelf and out of stock, or otherwise missing, items by combining image identification of item tags and machine readable codes, item tag optical character recognition, and computer vision based item identification techniques.

Embodiments provide for the identification of empty slots on shelf units using image data. Embodiments of the disclosure have a number of technical advantages. For example, embodiments reduce the amount of time and skill needed to manage the inventory of items on a shelf unit. A user (e.g., a transporter, an end user, etc.) can utilize a non-specialized device, such as user device (e.g., a smartphone), to obtain images of shelf units. As transporters, end users, and/or store employees enter the store, they may take images of the shelf units at more frequent intervals, and temporarily out of stock items on the shelf units can be determined in near real time. A computer can analyze the images and determine empty slots in the images that correspond to item tags. This allows for the rapid determination of missing or out of stock items. In some cases, the retailers may also be notified if an item is temporarily out of stock, such that the item can be replenished if the retailer has more of the item elsewhere (e.g., in a stock room).

Using images from many users to determine empty slots that relate to out of stock items is faster than individually scanning every barcode in a store. Doing so can allow item listings to be more accurate and up to date. This solves the problem of an end user selecting to have an item delivered that is actually out of stock, but is not yet updated in the item inventory.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, image data of an image of a shelf unit with specific items and item tags adjacent to the specific items, wherein the item tags comprise machine readable codes;
evaluating, by the computer, the image data to detect one or more empty slots on one or more shelves of the shelf unit; and
performing, by the computer, additional processing with respect to the one or more empty slots.

2. The method of claim 1, wherein evaluating the image data to detect the one or more empty slots comprises:
determining, by the computer, one or more empty slots using a computer vision machine learning model trained to detect empty slots in image data of shelf units.

3. The method of claim 1, wherein evaluating the image data to detect the one or more empty slots comprises:
determining, by the computer, one or more empty slots using a segment anything model.

4. The method of claim 1, wherein evaluating the image data to detect the one or more empty slots comprises:
determining, by the computer, one or more empty slots using a depth map.

5. The method of claim 1, wherein evaluating the image data to detect the one or more empty slots comprises:
identifying, by the computer, items and item tags on the shelf unit using a computer vision machine learning model that is trained to identify items and identify item tags;
determining, by the computer, item and item tag pairs based on the identified items and the identified item tags;
identifying, by the computer, item tags that do not correspond to identified items on the shelf unit and are not in an item and item tag pair; and
determining, by the computer, one or more empty slots based on the item tags that do not correspond to identified items.

6. The method of claim 1, wherein the image data is received from an image database, wherein a user device captured the image data of the shelf unit at a service provider location and provided the image data to a server computer, wherein the server computer stored the image data into the image database.

7. The method of claim 1, further comprising:
preprocessing, by the computer, the image data, wherein preprocessing includes mirroring, rotating, smoothing, contrast reduction, noise reduction, scaling, and/or rectifying the image data.

8. The method of claim 1, wherein the additional processing comprises:
identifying, by the computer, item tags associated with the shelf unit in the image data;
correlating, by the computer, the empty slots with one or more item tags of the item tags; and
determining, by the computer, items associated with the one or more item tags and the empty slots.

9. The method of claim 8, wherein the items associated with the one or more item tags and the empty slots are out of stock items.

10. The method of claim 8, wherein after determining the items, the method further comprises:
generating, by the computer, an item information data entry that indicates that the item is associated with an empty slot; and
storing, by the computer, the item information data entry into an item information database.

11. The method of claim 8, wherein the empty slots are correlated with the one or more item tags based on proximity in the image data.

12. The method of claim 8, further comprising:
determining, by the computer, item tag data for each item tag, wherein the item tag data includes an item identifier.

13. A computer comprising:
a processor; and
a computer-readable medium coupled to the processor, the computer-readable medium comprising code executable by the processor for implementing a method comprising:
receiving image data of an image of a shelf unit with specific items and item tags adjacent to the specific items, wherein the item tags comprise machine readable codes;
evaluating the image data to detect one or more empty slots on one or more shelves of the shelf unit; and
performing additional processing with respect to the one or more empty slots.

14. The computer of claim 13, wherein evaluating the image data to detect the one or more empty slots comprises:
identifying items and item tags on the shelf unit using a computer vision machine learning model, wherein the computer vision machine learning model is a you only look once model;
determining item and item tag pairs based on the identified items and the identified item tags;
identifying item tags that do not correspond to identified items on the shelf unit and are not in an item and item tag pair; and
determining one or more empty slots based on the item tags that do not correspond to identified items.

15. The computer of claim 14, wherein the additional processing comprises:
generating an item information data entry that indicates the item tags that do not correspond to identified items on the shelf unit; and
storing the item information data entry into an item information database.

16. The computer of claim 15, wherein a central server computer updates an item listing on a delivery application based on the item information data entry in the item information database.

17. The computer of claim 14, wherein the method further comprises:
determining additional information for each item based on the machine readable codes on the item tags, wherein the additional information includes an item identifier.

18. The computer of claim 17, wherein the machine readable codes include barcodes and/or QR codes.

19. A system comprising:
a central server computer;
an image database in communication with the central server computer; and
an image analysis computer in communication with the image database, the image analysis computer comprising:
a processor; and
a computer-readable medium coupled to the processor, the computer-readable medium comprising code executable by the processor for implementing a method comprising:
receiving, from the image database, image data of an image of a shelf unit with specific items and item tags adjacent to the specific items, wherein the item tags comprise machine readable codes, wherein the image data is stored in the image database by the central server computer;
evaluating the image data to detect one or more empty slots on one or more shelves of the shelf unit; and
performing additional processing with respect to the one or more empty slots.

20. The system of claim 19 further comprising:
a plurality of user devices that are in communication with the central server computer, wherein each user device of the plurality of user devices provides additional image data to the central server computer.
